(19) United States
(12) Patent Application Publication
(10) Pub. No.: US 2013/0011683 A1
(43) Pub. Date: Jan. 10, 2013

(54) OPTICAL ASSEMBLY HAVING A DISPLAY PANEL AND METHODS OF MAKING AND DISASSEMBLING SAME

(76) Inventors: Stanley C. Busman, North St. Paul, MN (US); Sunil K. Pillalamarri, Eagan, MN (US); Thu-Van T. Tran, Maplewood, MN (US); Christopher J. Campbell, Burnsville, MN (US)

(21) Appl. No.: 13/255,555

(22) PCT Filed: Mar. 24, 2011
(86) PCT No.: PCT/US11/29787

§ 371 Date: Sep. 9, 2011

(30) Foreign Application Priority Data
Mar. 24, 2010 (US) PCT/US10/28382
Aug. 27, 2010 (US) PCT/US10/47016

(51) Int. Cl. B32B 27/36; C08K 5/36; C08K 5/20; C08K 5/21; C08L 33/08; C08K 5/00

(52) U.S. Cl. 428/423.1; 428/480; 428/446; 524/560; 524/224; 524/216; 524/155; 524/198

(57) ABSTRACT

An optically clear adhesive layer includes a liquid optically clear adhesive having a viscosity of less than about 20 Pa·s at a shear rate of 1 sec⁻¹ and a thixotrope. The optically clear adhesive layer has a haze of about 2% or less, a viscosity of between about 2 and about 30 Pa·s at a shear rate of 10 sec⁻¹, a displacement creep of about 0.2 radians or less when a stress of 10 Pa is applied for about 2 minutes and a recovery time of about 60 seconds or less to reach a delta of 35 degrees after a torque of about 100 microN·m is applied for about 60 seconds at a frequency of 1 Hz and immediately followed by a torque of 80 microN·m at a frequency of 1 Hz. The adhesive layer can be used in an optical assembly to bond a display panel to a substantially transparent substrate. The adhesive layer provides a cleavage strength between glass substrates of about 15 N/mm or less such that the optical assembly can be disassembled with little or no damage to the display panel or the substrate. Optical assemblies and methods of making the optical assembly are also disclosed. The optical assembly may be used in an optical device such as a handheld device, a television, a computer monitor, a laptop display, or a digital sign.

### FIELD OF THE INVENTION

An optically clear adhesive layer that may be used in an optical assembly is disclosed. The optical assembly includes a display panel optically bonded to another optical component and may be used in a display device.

### BACKGROUND

Optical bonding may be used to adhere together two optical elements using an optical grade adhesive. In display applications, optical bonding may be used to adhere together optical elements such as display panels, glass plates, touch panels, diffusers, rigid compensators, heaters, and flexible films such as polarizers and retarders. The optical performance of a display can be improved by minimizing the number of internal reflecting surfaces, thus it may be desirable to remove or at least minimize the number of air gaps between optical elements in the display.

### SUMMARY

In one embodiment, an optically clear adhesive layer includes a liquid optically clear adhesive having a viscosity of less than about 20 Pa·s at a shear rate of 1 sec⁻¹ and a thixotrope. The optically clear adhesive layer has a haze of about 2% or less, a viscosity of between about 2 and about 30 Pa·s at a shear rate of 10 sec⁻¹, a displacement creep of about 0.2 radians or less when a stress of 10 Pa is applied for about 2 minutes and a recovery time of about 60 seconds or less to reach a delta of 35 degrees after a torque of about 1000 microN·m is applied for about 60 seconds at a frequency of 1 Hz and immediately followed by a torque of 80 microN·m at a frequency of 1 Hz.

In another embodiment, an optical assembly comprising a display panel is disclosed herein. The optical assembly comprises: a display panel; a substantially transparent substrate; and an adhesive layer disposed between the display panel and the substantially transparent substrate.

The optical assembly disclosed herein may be used in an optical device comprising, for example, a handheld device comprising a display, a television, a computer monitor, a laptop display, or a digital sign.

In another embodiment, a method of making an optical assembly is disclosed.

These and other aspects of the invention are described in the detailed description below. In no event should the above summary be construed as a limitation on the claimed subject matter which is defined solely by the claims as set forth herein.

### DETAILED DESCRIPTION

Optical materials may be used to fill gaps between optical components or substrates of optical assemblies. Optical assemblies comprising a display panel bonded to an optical substrate may benefit if the gap between the two is filled with an optical material that matches or nearly matches the refractive indices of the panel and the substrate. For example, sunlight and ambient light reflection inherent between a display panel and an outer cover sheet may be reduced. Color gamut and contrast of the display panel can be improved under ambient conditions. Optical assemblies having a filled gap can also exhibit improved shock-resistance compared to the same assemblies having an air gap.

Optical materials used to fill gaps between optical components or substrates typically comprise adhesives and various types of cured polymeric compositions. However, these optical materials are not useful for making an optical assembly if, at a later time, one wishes to disassemble or rework the assembly with little or no damage to the components. This reworkability feature is needed for optical assemblies because the components tend to be fragile and expensive. For example, a cover sheet often needs to be removed from a display panel if flaws are observed during or after assembly or if the cover sheet is damaged after sale. It is desirable to rework the assembly by removing the cover sheet from the display panel with little or no damage to the components. Reworkability is becoming increasingly important as the size or area of available display panels continues to increase.

An optical assembly having a large size or area can be difficult to manufacture, especially if efficiency and stringent optical quality are desired. A gap between optical components may be filled by pouring or injecting a curable composition into the gap followed by curing the composition to bond the components together. However, these commonly used compositions have long flow-out times which contribute to inefficient manufacturing methods for large optical assemblies.

The optical assembly disclosed herein comprises an adhesive layer and optical components, particularly a display panel and a substantially light transmissive substrate. The adhesive layer allows one to rework the assembly with little or no damage to the components. The adhesive layer may have a cleavage strength between glass substrates of about 15 N/mm or less, 10 N/mm or less, or 6 N/mm or less, such that reworkability can be obtained with little or no damage to the components. Total energy to cleavage can be less than about 25 kg*mm over a 1″×1″ area.

The adhesive layer is suitable for optical applications. For example, the adhesive layer may have at least 85% transmission over the range of from 460 to 720 nm. The adhesive layer may have, per millimeter thickness, a transmission of greater than about 85% at 460 nm, greater than about 90% at 530 nm, and greater than about 90% at 670 nm. These transmission characteristics provide for uniform transmission of light across the visible region of the electromagnetic spectrum which is important to maintain the color point in full color displays.

The color portion of the transparency characteristics of the adhesive layer is further defined by its color coordinates as represented by the CIE L*a*b* convention. For example, the b* component of color should be less than about 1, more preferably less than about 0.5. These characteristics of b* provide for a low yellowness index which is important to maintain the color point in full color displays.

The haze portion of the transparency characteristics of the adhesive layer is further defined by the % haze value of the adhesive layer as measured by haze meters such as a HazeGard Plus available from Byk Gardner or an UltraScan Pro available from Hunter Labs. For example the percent haze of the adhesive layer should be less than about 2%, more preferably less than about 1%. These haze characteristics provide for low light scattering which is important to maintain the quality of the output in full color displays.

For reasons described above, the adhesive layer preferably has a refractive index that matches or closely matches that of the display panel and/or the substantially transparent substrate. The refractive index of the adhesive can be controlled by the proper choice of adhesive components. For example, the refractive index can be increased by incorporating oligomers, diluting monomers and the like which contain a higher content of aromatic structure or incorporate sulfur or halogens such as bromine. Conversely the refractive index can be adjusted to lower values by incorporating oligomer, diluting monomers and the like that contain a higher content of aliphatic structure. For example, the adhesive layer may have a refractive index of from about 1.4 to about 1.7.

The adhesive may remain transparent by the proper choice of adhesive components including oligomers, diluting monomers, fillers, plasticizers, tackifying resins, photoinitiators and any other component which contributes to the overall properties of the adhesive. In particular, the adhesive components should be compatible with each other, for example they should not phase separate before or after cure to the point where domain size and refractive index differences cause light scattering and haze to develop, unless haze is a desired outcome, such as for diffuse adhesive applications. In addition the adhesive components should be free of particles that do not dissolve in the adhesive formulation and are large enough to scatter light, and thereby contribute to haze. If haze is desired, such as in diffuse adhesive applications, this may be acceptable. In addition, various fillers such as thixotropic materials should be so well dispersed that they do not contribute to phase separation or light scattering which can contribute to a loss of light transmission and an increase in haze. Again, if haze is desired, such as in diffuse adhesive applications, this may be acceptable. These adhesive components also should not degrade the color characteristics of transparency by, for example, imparting color or increasing the b* or yellowness index of the adhesive layer.

The adhesive layer can be used in optical assembly comprising: a display panel; a substantially transparent substrate; and the adhesive layer disposed between the display panel and the substantially transparent substrate. The adhesive layer may have any thickness. The particular thickness employed in the optical assembly may be determined by any number of factors, for example, the design of the optical device in which the optical assembly is used may require a certain gap between the display panel and the substantially transparent substrate. The adhesive layer typically has a thickness of from about 1 μm to about 5 mm, from about 50 μm to about 1 mm, or from about 50 μm to about 0.2 mm.

The adhesive layer may be made using a liquid optically clear adhesive or liquid composition in combination with a thixotrope, wherein the liquid composition has a viscosity suitable for efficient manufacturing of large optical assemblies. A large optical assembly may have an area of from about 15 cm² to about 5 m² or from about 15 cm² to about 1 m². For example, the liquid composition may have a viscosity of from about 100 to 140,000 cps, from about 100 to about 10,000 cps, from about 100 to about 5000 cps, from about 100 to about 1000 cps, from about 200 to about 700 cps, from about 200 to about 500 cps, or from about 500 to about 4000 cps, wherein viscosity is measured for the composition at 25° C. and 1 sec⁻¹. The liquid composition is amenable for use in a variety of manufacturing methods.

The adhesive layer can include any liquid optically clear adhesive having a viscosity such that when combined with a thixothrope, the adhesive layer has a viscosity of no more than 30 Pa·s, between about 2 and about 30 Pa·s and particularly between about 5 and about 20 Pa·s at a shear rate of 1 to 10 sec⁻¹. This range at 1-10 sec⁻¹ governs the ability of the adhesive layer to flow underneath a squeegee used during, for example, stencil printing, such that the adhesive layer does not adhere to the squeegee at higher squeegee speeds. In addition this viscosity is low enough to fill the cavity of the stencil with fluid without entrapping air bubbles or having insufficient flow to fill the cavity completely with liquid adhesive fluid. The range of 1-10 sec⁻¹ governs the ability of the adhesive layer to flow underneath a squeegee at slower speeds. At 1 sec⁻¹, the adhesive layer had a viscosity of between about 18 and about 140 Pa·s. At 0.01 sec⁻¹, the adhesive layer has a viscosity of at least 700 Pa·s, at least 2,000 Pa·s and preferably at least 10,000 Pa·s. The range at 0.01 sec⁻¹ defines when the adhesive layer has non-sag properties.

In one embodiment, the liquid optically clear adhesive used in the adhesive layer has a viscosity of about 20 Pa·s or less at a shear rate of 1-10 sec⁻¹. In particular, the liquid optically clear adhesive has a viscosity of about 10 Pa·s or less and more particularly about 5 Pa·s or less at a shear rate of 1-10 sec⁻¹. Within these ranges, the viscosity of the adhesive layer will be in the appropriate range when a thixothrope is added.

In one embodiment, the adhesive layer includes the reaction product of a multifunctional (meth)acrylate oligomer, a reactive diluent comprising a monofunctional (meth)acrylate monomer having a viscosity of from about 4 to about 20 cps at 25° C.; and a plasticizer. In general, (meth)acrylate refers to both acrylate and methacrylate functionality.

The multifunctional (meth)acrylate oligomer may comprise any one or more of: a multifunctional urethane(meth)acrylate oligomer, a multifunctional polyester(meth)acrylate oligomer, and a multifunctional polyether(meth)acrylate oligomer. The multifunctional (meth)acrylate oligomer may comprise at least two (meth)acrylate groups, e.g., from 2 to 4 (meth)acrylate groups, that participate in polymerization during curing. The adhesive layer may comprise from about 15 to about 50 wt. %, from about 20 to about 60 wt. %, or from about 20 to about 45 wt. %, of the multifunctional (meth)acrylate oligomer. The particular multifunctional (meth)acrylate oligomer used, as well as the amount used, may depend on a variety of factors. For example, the particular oligomer and/or the amount thereof may be selected such that the adhesive composition is a liquid composition having a viscosity of from about 100 to 140,000 cps, from about 100 to about 10,000 cps, from about 100 to about 5000 cps, from about 100 to about 1000 cps, from about 200 to about 700 cps, from about 200 to about 500 cps, or from about 500 to about 4000 cps, wherein viscosity is measured for the composition at 25° C. and 1 sec⁻¹. For another example, the particular oligomer and/or the amount thereof may be selected such that the adhesive composition is a liquid composition having a viscosity of from about 100 to 140,000 cps, from about 100 to about 10,000 cps, from about 100 to about 5000 cps, from about 100 to about 1000 cps, from about 200 to about 700 cps, from about 200 to about 500 cps, or from about 500 to about 4000 cps, wherein viscosity is measured for the composition at 25° C. and 1 sec⁻¹ and the resulting adhesive layer has a Shore A hardness of less than about 30, less than about 20 or less than about 10. For yet another example, the particular oligomer and/or the amount thereof may be selected such that the adhesive composition is a liquid composition having a viscosity of 18,000 cps to 140,000 cps for the composition at 25° C. and shear rate 1 sec⁻¹, and a viscosity of 700,000 cps to 4,200,000 cps for the composition at 25° C. and shear rate 0.01 sec⁻¹.

The multifunctional (meth)acrylate oligomer may comprise a multifunctional urethane(meth)acrylate oligomer having at least two (meth)acrylate groups, e.g., from 2 to 4 (meth)acrylate groups, that participate in polymerization during curing. In general, these oligomers comprise the reaction product of a polyol with a multifunctional isocyanate, followed by termination with a hydroxy-functionalized (meth)acrylate. For example, the multifunctional urethane(meth)acrylate oligomer may be formed from an aliphatic polyester or polyether polyol prepared from condensation of a dicarboxylic acid, e.g., adipic acid or maleic acid, and an aliphatic diol, e.g. diethylene glycol or 1,6-hexane diol. In one embodiment, the polyester polyol comprises adipic acid and diethylene glycol. The multifunctional isocyanate may comprise methylene dicyclohexylisocyanate or 1,6-hexamethylene diisocyanate. The hydroxy-functionalized (meth)acrylate may comprise a hydroxyalkyl(meth)acrylate such as 2-hydroxyethyl acrylate, 2-hydroxypropyl(meth)acrylate, 4-hydroxybutyl acrylate, or polyethylene glycol(meth)acrylate. In one embodiment, the multifunctional urethane(meth)acrylate oligomer comprises the reaction product of a polyester polyol, methylene dicyclohexylisocyanate, and hydroxyethyl acrylate.

Useful multifunctional urethane(meth)acrylate oligomers include products that are commercially available. For example, the multifunctional aliphatic urethane(meth)acrylate oligomer may comprise urethane diacrylate CN9018, CN3108, and CN3211 available from Sartomer, Co., Exton, Pa., GENOMER 4188/EHA (blend of GENOMER 4188 with 2-ethylhexyl acrylate), GENOMER 4188/M22 (blend of GENOMER 4188 with GENOMER 1122 monomer), GENOMER 4256, and GENOMER 4269/M22 (blend of GENOMER 4269 and GENOMER 1122 monomer) available from Rahn USA Corp., Aurora Ill.; U-Pica 8966, 8967, 8967A and combinations thereof, available from Japan U-Pica Corp., and polyether urethane diacrylate BR-3042, BR-3641AA, BR-3741AB, and BR-344 available from Bomar Specialties Co., Torrington, Conn.

In general, the multifunctional urethane(meth)acrylate oligomer may be used in any amount depending on other components used to form the adhesive layer as well as the desired properties of the adhesive layer. The adhesive layer may comprise from about 15 to about 50 wt. %, from about 20 to about 60 wt. %, or from about 20 to about 45 wt. %, of the multifunctional urethane(meth)acrylate oligomer.

The multifunctional (meth)acrylate oligomer may comprise a multifunctional polyester(meth)acrylate oligomer. Useful multifunctional polyester acrylate oligomers include products that are commercially available. For example, the multifunctional polyester acrylate may comprise BE-211 available from Bomar Specialties Co. and CN2255 available from Sartomer Co.

The multifunctional (meth)acrylate oligomer may comprise a multifunctional polyether(meth)acrylate oligomer. Useful multifunctional polyether acrylate oligomers include products that are commercially available. For example, the multifunctional polyether acrylate may comprise GENOMER 3414 available from Rahn USA Corp.

The reaction product that forms the adhesive layer is formed from a reactive diluent. The reactive diluent comprises a monofunctional (meth)acrylate monomer having a viscosity of from about 4 to about 20 cps at 25° C. The reactive diluent may comprise more than one monomer, for example, from two to five different monomers. Examples of these monomers include isobornyl acrylate, isobornyl(meth)acrylate, tetrahydrofurfuryl acrylate, tetrahydrofurfuryl methacrylate, alkoxylated tetrahydrofurfuryl acrylate, alkoxylated methacrylate, tetrahydrofurfuryl methacrylate and mixtures thereof. For example, the reactive diluent may comprise tetrahydrofurfuryl(meth)acrylate and isobornyl(meth)acrylate. For another example, the reactive diluent may comprise alkoxylated tetrahydrofurfuryl acrylate and isobornyl acrylate.

In general, the reactive diluent may be used in any amount depending on other components used to form the adhesive layer as well as the desired properties of the adhesive layer. The adhesive layer may comprise from about 15 to about 50 wt. %, from about 30 to about 60 wt. %, or from about 40 to about 60 wt. %, of the reactive diluent, relative to the total weight of the adhesive layer.

The particular reactive diluent used, and the amount(s) of monomer(s) used, may depend on a variety of factors. For example, the particular monomer(s) and amount(s) thereof may be selected such that the adhesive composition is a liquid composition having a viscosity of from about 100 to 140,000 cps, from about 100 to about 10,000 cps, from about 100 to about 5000 cps, from about 100 to about 1000 cps, from about 200 to about 700 cps, from about 200 to about 500 cps, or from about 500 to about 4000 cps, wherein viscosity is measured for the composition at 25° C. and 1 sec⁻¹. For another example, the particular monomer(s) and amount(s) thereof may be selected such that the adhesive composition is a liquid composition having a viscosity of from about 100 to 140,000 cps, from about 100 to about 10,000 cps, from about 100 to about 5000 cps, from about 100 to about 1000 cps, from about 200 to about 700 cps, from about 200 to about 500 cps, or from about 500 to about 4000 cps, wherein viscosity is measured for the composition at 25° C. and 1 sec⁻¹ and the resulting adhesive layer has a Shore A hardness of less than about 30, less than about 20 or less than about 10. For yet another example, the particular diluent and/or the amount thereof may be selected such that the adhesive composition is a liquid composition having a viscosity of 18,000 cps to 140,000 cps for the composition at 25° C. and shear rate 1 sec⁻¹ and a viscosity of 700,000 cps to 4,200,000 cps for the composition at 25° C. and shear rate 0.01 sec⁻¹.

The adhesive layer comprises a plasticizer that increases its softness and flexibility. Plasticizers are well known and typically do not participate in polymerization of (meth)acrylate groups. The plasticizer may comprise more than one plasticizer material. The plasticizer may comprise an oil. Suitable oils include vegetable oil, mineral oil and soybean oil. The adhesive layer may comprise from greater than 5 to about 20 wt. %, or from greater than 5 to about 15 wt. %, of the plasticizer. The particular plasticizer used, as well as the amount used, may depend on a variety of factors. For example, the particular plasticizer and/or the amount thereof may be selected such that the adhesive composition is a liquid composition having a viscosity of from about 100 to 140,000 cps, from about 100 to about 10,000 cps, from about 100 to about 5000 cps, from about 100 to about 1000 cps, from about 200 to about 700 cps, from about 200 to about 500 cps, or from about 500 to about 4000 cps, wherein viscosity is measured for the composition at 25° C. and 1 sec⁻¹. For another example, the particular plasticizer and/or the amount thereof may be selected such that the adhesive composition is a liquid composition having a viscosity of from about 100 to 140,000 cps, from about 100 to about 10,000 cps, from about 100 to about 5000 cps, from about 100 to about 1000 cps, from about 200 to about 700 cps, from about 200 to about 500 cps, or from about 500 to about 4000 cps, wherein viscosity is measured for the composition at 25° C. and 1 sec⁻¹ and the resulting adhesive layer has a Shore A hardness of less than about 30, less than about 20 or less than about 10. For yet another example, the particular plasticizer and/or the amount thereof may be selected such that the adhesive composition is a liquid composition having a viscosity of 18,000 cps to 140,000 cps for the composition at 25° C. and shear rate of 1 sec⁻¹ and a viscosity of 700,000 cps to 4,200,000 cps for the composition at 25° C. and shear rate 0.01 sec⁻¹.

The reaction product that forms the adhesive layer may further comprise a monofunctional (meth)acrylate monomer having alkylene oxide functionality. This monofunctional (meth)acrylate monomer having alkylene oxide functionality may comprise more than one monomer. Alkylene functionality includes ethylene glycol and propylene glycol. The glycol functionality is comprised of units, and the monomer may have anywhere from 1 to 10 alkylene oxide units, from 1 to 8 alkylene oxide units, or from 4 to 6 alkylene oxide units. The monofunctional (meth)acrylate monomer having alkylene oxide functionality may comprise propylene glycol monoacrylate available as BISOMER PPA6 from Cognis Ltd. This monomer has 6 propylene glycol units. The monofunctional (meth)acrylate monomer having alkylene oxide functionality may comprise ethylene glycol monomethacrylate available as BISOMER MPEG350MA from Cognis Ltd. This monomer has on average 7.5 ethylene glycol units.

The adhesive layer may comprise from about 5 to about 30 wt. %, or from about 10 to about 20 wt. %, of the monofunctional (meth)acrylate monomer having alkylene oxide functionality. The particular monomer used, as well as the amount used, may depend on a variety of factors. For example, the particular monomer and/or the amount thereof may be selected such that the adhesive composition is a liquid composition having a viscosity of from about 100 to 140,000 cps, from about 100 to about 10,000 cps, from about 100 to about 5000 cps, from about 100 to about 1000 cps, from about 200 to about 700 cps, from about 200 to about 500 cps, or from about 500 to about 4000 cps, wherein viscosity is measured for the composition at 25° C. and 1 sec⁻¹. For another example, the particular monomer and/or the amount thereof may be selected such that the adhesive composition is a liquid composition having a viscosity of from about 100 to 140,000 cps, from about 100 to about 10,000 cps, from about 100 to about 5000 cps, from about 100 to about 1000 cps, from about 200 to about 700 cps, from about 200 to about 500 cps, or from about 500 to about 4000 cps, wherein viscosity is measured for the composition at 25° C. and 1 sec⁻¹ and the resulting adhesive layer has a Shore A hardness of less than about 30, less than about 20 or less than about 10. For yet another example, the particular monomer and/or the amount thereof may be selected such that the adhesive composition is a liquid composition having a viscosity of 18,000 cps to 140,000 cps for the composition at 25° C. and shear rate 1 sec⁻¹ and a viscosity of 700,000 cps to 4,200,000 cps for the composition at 25° C. and shear rate 0.01 sec⁻¹.

The adhesive layer has little or no tackifier as described above. Tackifiers are typically used to increase the tackiness of an adhesive. The particular tackifier used, as well as the amount used, may depend on a variety of factors. The tackifier and/or the amount thereof may be selected such that the adhesive layer has a cleavage strength between glass substrates of about 15 N/mm or less, 10 N/mm or less, or 6 N/mm or less. The particular tackifier and/or the amount thereof may be selected such that the adhesive composition is a liquid composition having a viscosity of from about 100 to 140,000 cps, from about 100 to about 10,000 cps, from about 100 to about 5000 cps, from about 100 to about 1000 cps, from about 200 to about 700 cps, from about 200 to about 500 cps, or from about 500 to about 4000 cps, wherein viscosity is measured for the composition at 25° C. and 1 sec⁻¹. For another example, the particular tackifier and/or the amount thereof may be selected such that the adhesive composition is a liquid composition having a viscosity of from about 100 to 140,000 cps, from about 100 to about 10,000 cps, from about 100 to about 5000 cps, from about 100 to about 1000 cps, from about 200 to about 700 cps, from about 200 to about 500 cps, or from about 500 to about 4000 cps, wherein viscosity is measured for the composition at 25° C. and 1 sec⁻¹ and the resulting adhesive layer has a Shore A hardness of less than about 30 less than about 20 or less than about 10. For yet another example, the particular tackifier and/or the amount thereof may be selected such that the adhesive composition is a liquid composition having a viscosity of 18,000 cps to 140,000 cps for the composition at 25° C. and shear rate 1 sec⁻¹ and a viscosity of 700,000 cps to 4,200,000 cps for the composition at 25° C. and shear rate 0.01 sec⁻¹.

The adhesive layer may comprise: the reaction product of from about 15 to about 50 wt. % of the multifunctional (meth)acrylate oligomer, and from about 15 to about 50 wt. % of the reactive diluent; and from greater than 5 to about 25 wt. % of the plasticizer. The reaction product may further comprise from about 10 to about 20 wt. % of a monofunctional (meth)acrylate monomer having alkylene oxide functionality. This adhesive layer may comprise a glass-to-glass cleavage force less than about 15 N/mm, less than about 10 N/mm, or less than about 6 N/mm.

The adhesive layer may comprise: the reaction product of from about 20 to about 60 wt. % of the multifunctional (meth)acrylate oligomer, and from about 30 to about 60 wt. % of the reactive diluent; and from greater than 5 to about 25 wt. % of the plasticizer. The reaction product may further comprise from about 10 to about 20 wt. % of a monofunctional (meth)acrylate monomer having alkylene oxide functionality. This adhesive layer may comprise a glass-to-glass cleavage force less than about 15 N/mm, less than about 10 N/mm, or less than about 6 N/mm.

The adhesive layer may comprise: the reaction product of from about 25 to about 45 wt. % of the multifunctional (meth)acrylate oligomer, and from about 40 to about 60 wt. % of the reactive diluent; and from greater than 5 to about 15 wt. % of the plasticizer. The reaction product may further comprise from about 10 to about 20 wt. % of a monofunctional (meth)acrylate monomer having alkylene oxide functionality. The adhesive layer may comprise: the reaction product of from about 20 to about 50 wt. % of the multifunctional urethane(meth)acrylate oligomer, and from about 30 to about 60 wt. % of the reactive diluent; and from greater than 5 to about 25 wt. % of the plasticizer. The reaction product may further comprise from about 10 to about 20 wt. % of a monofunctional (meth)acrylate monomer having alkylene oxide functionality. The adhesive layer may comprise: the reaction product of from about 25 to about 45 wt. % of the multifunctional urethane(meth)acrylate oligomer, and from about 40 to about 60 wt. % of the reactive diluent; and from greater than 5 to about 15 wt. % of the plasticizer. The reaction product may further comprise from about 10 to about 20 wt. % of a monofunctional (meth)acrylate monomer having alkylene oxide functionality. The adhesive layer may comprise: the reaction product of from about 30 to about 60 wt. % of the multifunctional urethane(meth)acrylate oligomer, and from about 20 to about 30 wt. % of the reactive diluent; and from greater than 5 to about 10 wt. % of the plasticizer; from about 5 to about 10 wt. % of a monofunctional (meth)acrylate monomer having alkylene oxide functionality, and from about 2 to about 10 wt. % of fumed silica.

The optical assembly may comprise a display panel; a substantially transparent substrate; and an adhesive layer disposed between the display panel and the substantially transparent substrate, the adhesive layer comprising: the reaction product of a multifunctional rubber-based (meth)acrylate oligomer, and a monofunctional (meth)acrylate monomer having a pendant alkyl group of from 4 to 20 carbon atoms; and a liquid rubber.

The multifunctional rubber-based (meth)acrylate oligomer comprising any one or more of: a multifunctional polybutadiene(meth)acrylate oligomer, a multifunctional isoprene(meth)acrylate oligomer, and a multifunctional (meth)acrylate oligomer comprising a copolymer of butadiene and isoprene. The multifunctional rubber-based (meth)acrylate oligomer may comprise a multifunctional polybutadiene(meth)acrylate oligomer. The monofunctional (meth)acrylate monomer having a pendant alkyl group of from 4 to 20 carbon atoms may comprise a pendant group having from 8 to 20 carbon atoms. The liquid rubber may comprise liquid isoprene.

Useful multifunctional polybutadiene(meth)acrylate oligomers include the difunctional polybutadiene(meth)acrylate oligomer CN307 available from Sartomer Co. Useful multifunctional polyisoprene(meth)acrylate oligomers include the methacrylated isoprene oligomers UC-102 and UC-203 available from Kuraray America, Inc.

Useful monofunctional (meth)acrylate monomers having pendant alkyl groups of from 4 to 20 carbon atoms include 2-ethylhexyl acrylate, lauryl acrylate, isodecyl acrylate, and stearyl acrylate.

Liquid rubber may comprise LIR-30 liquid isoprene rubber and LIR-390 liquid butadiene/isoprene copolymer rubber available from Kuraray, Inc. and RICON 130 liquid polybutadiene rubber available from Sartomer Co., Inc.

The adhesive layer may further comprise a plasticizer as described above.

The adhesive layer may comprise: the reaction product of from about 20 to about 60 wt. % of the multifunctional rubber-based (meth)acrylate oligomer, and from about 20 to about 60 wt. % of the monofunctional (meth)acrylate monomer having a pendant alkyl group of from 4 to 20 carbon atoms; and from greater than 5 to about 25 wt. % of the liquid rubber.

The adhesive layer may comprise: the reaction product of from about 20 to about 50 wt. % of the multifunctional rubber-based (meth)acrylate oligomer, and from about 20 to about 50 wt. % of the monofunctional (meth)acrylate monomer having a pendant alkyl group of from 4 to 20 carbon atoms; and from greater than 5 to about 25 wt. % of the liquid rubber.

The adhesive layer comprises little or no tackifier as described above.

The adhesive layer may comprise tackifier. Tackifiers are well known and are used to increase the tack or other properties of an adhesive. There are many different types of tackifiers but nearly any tackifier can be classified as: a rosin resin derived from wood rosin, gum rosin or tall oil rosin; a hydrocarbon resin made from a petroleum based feedstock; or a terpene resin derived from terpene feedstocks of wood or certain fruits. The adhesive layer may comprise, e.g., from 0.01 to about 20 wt. %, from 0.01 to about 15 wt. %, or from 0.01 to about 10 wt. % of tackifier. The adhesive layer may be substantially free of tackifier comprising, e.g., from 0.01 to about 5 wt. % or from about 0.01 to about 0.5 wt. % of tackifier all relative to the total weight of the adhesive layer. The adhesive layer may be free of tackifier.

The adhesive layer may be soft, for example, the layer may have a Shore A hardness of less than about 30, less than about 20 or less than about 10.

The adhesive layer may exhibit little or no shrinkage, e.g., less than about 5%, depending on whatever amount is acceptable.

In another embodiment, the adhesive may be silicone based. For example the adhesive may be using addition curing chemistry between a silicon hydride functional silicone and a vinyl or allyl functional silicone. Addition curing silicones are well known in the art and they often incorporate platinum based catalysts that can be activated by heat or UV irradiation. Likewise two-component silicone liquid adhesives or gel forming materials may be used as the basis for this thixotropic, printable material. These types of silicones may rely on condensation chemistry and require heat to accelerate the curing mechanism.

In general, the adhesive layer may comprise metal oxide particles, for example, to modify the refractive index of the adhesive layer or the viscosity of the liquid adhesive composition (as described below). Metal oxide particles that are substantially transparent may be used. For example, a 1 mm thick disk of the metal oxide particles in an adhesive layer may absorb less than about 15% of the light incident on the disk. Examples of metal oxide particles include clay, Al₂O₃, ZrO₂, TiO₂, V₂O₅, ZnO, SnO₂, ZnS, SiO₂, and mixtures thereof, as well as other sufficiently transparent non-oxide ceramic materials. The metal oxide particles can be surface treated to improve dispersibility in the adhesive layer and the composition from which the layer is coated. Examples of surface treatment chemistries include silanes, siloxanes, carboxylic acids, phosphonic acids, zirconates, titanates, and the like. Techniques for applying such surface treatment chemistries are known. Organic fillers such as cellulose, castor-oil wax and polyamide-containing fillers may also be used.

In some embodiments, the adhesive layer comprises a fumed silica. Suitable fumed silicas include, but are not limited to: AEROSIL 200; and AEROSIL R805 (both available from Evonik Industries); CAB-O-SIL TS 610; and CAB-O-SIL T 5720 (both available from Cabot Corp.), and HDK H2ORH (available from Wacker Chemie AG).

In some embodiments, the adhesive layer comprises a fumed aluminum oxide, such as AEROXIDE ALU 130 (available from Evonik, Parsippany, N.J.).

In some embodiments, the adhesive layer comprises clay such as GARAMITE 1958 (available from Southern Clay Products).

Metal oxide particles may be used in an amount needed to produce the desired effect, for example, in an amount of from about 2 to about 10 wt. %, from about 3.5 to about 7 wt. %, from about 10 to about 85 wt. %, or from about 40 to about 85 wt. %, based on the total weight of the adhesive layer. Metal oxide particles may only be added to the extent that they do not add undesirable color, haze or transmission characteristics. Generally, the particles can have an average particle size of from about 1 nm to about 100 nm.

In some embodiments, the liquid optically clear adhesive comprises non-reactive oligomeric rheology modifiers. While not wishing to be bound by theory, non-reactive oligomeric rheology modifiers build viscosity at low shear rates through hydrogen bonding or other self-associating mechanisms. Examples of suitable non-reactive oligomeric rheology modifiers include, but are not limited to: polyhydroxycarboxylic acid amides (such as BYK 405, available from Byk-Chemie GmbH, Wesel, Germany), polyhydroxycarboxylic acid esters (such as BYK R-606, available from Byk-Chemie GmbH, Wesel, Germany), modified ureas (such as DISPARLON 6100, DISPARLON 6200 or DISPARLON 6500 from King Industries, Norwalk, Conn. or BYK 410 from Byk-Chemie GmbH, Wesel, Germany), metal sulfonates (such as K-STAY 501 from King Industries, Norwalk, Conn. or IRCOGEL 903 from Lubrizol Advanced Materials, Cleveland, Ohio), acrylated oligoamines (such as GENOMER 5275 from Rahn USA Corp, Aurora, Ill.), polyacrylic acids (such as CARBOPOL 1620 from Lubrizol Advanced Materials, Cleveland, Ohio), modified urethanes (such as K-STAY 740 from King Industries, Norwalk, Conn.), or polyamides. In some embodiments, non-reactive oligomeric rheology modifiers are chosen to be miscible and compatible with the optically clear adhesive to limit phase separation and minimize haze.

In some embodiments, the adhesive layer may be formed from a thixotropic liquid optically clear adhesive. As used herein, a composition is considered thixotropic if the composition shear thins, i.e., viscosity decreases when the composition is subjected to a shearing stress over a given period of time with subsequent recovery or partial recovery of viscosity when the shearing stress is decreased or removed. Such adhesives exhibit little or no flow under zero or near-zero stress conditions. The advantage of the thixotropic property is that the adhesive can be dispensed easily by such processes as needle dispensing due to the rapid decrease in viscosity under low shear rate conditions. The main advantage of thixotropic behavior over simply high viscosity is that high viscosity adhesive is difficult to dispense and to flow during application. Adhesive compositions can be made thixotropic by adding particles to the compositions. In some embodiments, fumed silica is added to impart thixotropic properties to a liquid adhesive, in an amount of from about 2 to about 10 wt. %, or from about 3.5 to about 7 wt. %.

In some embodiments, any liquid optically clear adhesive having a viscosity of no more than 30 Pa·s, between about 2 and about 30 Pa·s and particularly between about 5 and about 20 Pa·s at a shear rate of 1 to 10 sec⁻¹ can be combined with a thixotropic agent to form a thixotropic liquid optically clear adhesive suitable for stencil printing or screen printing. The efficiency of the thixotropic agent and the optical properties depend on the composition of the liquid optically clear adhesive and its interaction with the thixotropic agent. For example, in the case of associative thixotropes or hydrophilic silica, the presence of highly polar monomers such as acrylic acid, acid or hyxdroxyl containing monomers or oligomers may disrupt the thixotropic or optical performance.

In some embodiments, the viscosities of the liquid optically clear adhesive may be controlled at two or more different shear rates. In one embodiment, the adhesive layer has a viscosity of between about 2 and about 30 Pa·s and particularly between about 5 and about 20 Pa·s at 25° C. and a shear rate of 10 sec⁻¹. In one embodiment, the adhesive layer has a viscosity of between about 700 and about 10,000 Pa·s and particularly between about 1,000 and about 8,000 Pa·s at 25° C. and a shear rate of 0.01 sec °. In one embodiment, the adhesive layer has a viscosity of between about 18 Pa·s and about 140 Pa·s and particularly between about 30 Pa·s and about 100 Pa·s at 25° C. and shear rate 1 sec⁻¹.

In some embodiments, the adhesive layer has a displacement creep of about 0.2 radians or less when a stress of 10 Pa is applied to the adhesive for 2 minutes. Particularly, the liquid optically clear adhesive has a displacement creep of about 0.1 radians or less when a stress of 10 Pa is applied to the adhesive for 2 minutes. In general, displacement creep is a value determined by using an AR2000 Rheometer manufactured by TA Instruments and a 40 mm diameter×1° cone at 25° C., and is defined as the rotational angle of the cone when a stress of 10 Pa is applied to the adhesive. The displacement creep is related to the ability of the thixotropic adhesive layer to resist flow, or sag, under very low stress conditions, such as gravity and surface tension.

In some embodiments, the liquid optically clear adhesive has a delta of 45 degrees or less, particularly 42 or less, particularly 35 degrees or less and more particularly 30 degrees or less when a torque of 80 microN·m is applied at a frequency of 1 Hz in a cone and plate rheometer. Delta is the phase lag between stress and strain where an oscillatory force (stress) is applied to a material and the resulting displacement (strain) is measured. Delta is assigned units of degrees. The delta is related to the “solid” behavior of the thixotropic adhesive layer or its non-sag property at very low oscillatory stress.

The adhesive layer also has the ability to regain its non-sag structure within a short amount of time after passing underneath equipment, such as a squeegee in stencil printing applications. In one embodiment, the recovery time of the adhesive layer is less than about 60 seconds, particularly less than about 30 seconds, and more particularly less than about 10 seconds to reach a delta of 35 degrees after a torque of about 1000 microN·m is applied for about 60 seconds at a frequency of 1 Hz and immediately followed by a torque of 80 microN·m at a frequency of 1 Hz.

Photoinitiators may be used in the liquid compositions when curing with UV-radiation. Photoinitiators for free radical curing include organic peroxides, azo compounds, quinines, nitro compounds, acyl halides, hydrazones, mercapto compounds, pyrylium compounds, imidazoles, chlorotriazines, benzoin, benzoin alkyl ethers, ketones, phenones, and the like. For example, the adhesive compositions may comprise ethyl-2,4,6-trimethylbenzoylphenylphosphinate available as LUCIRIN TPO-L from BASF Corp. or 1-hydroxycyclohexyl phenyl ketone available as IRGACURE 184 from Ciba Specialty Chemicals. The photoinitiator is often used at a concentration of about 0.1 to 10 weight percent or 0.1 to 5 weight percent based on the weight of oligomeric and monomer material in the polymerizable composition.

The liquid compositions and adhesive layers can optionally include one or more additives such as chain transfer agents, antioxidants, stabilizers, fire retardants, viscosity modifying agents, antifoaming agents, antistatic agents and wetting agents. If color is required for the optical adhesive colorants such as dyes and pigments, fluorescent dyes and pigments, phosphorescent dyes and pigments can be used.

The adhesive layers described above are formed by curing an adhesive composition or liquid composition. Any form of electromagnetic radiation may be used, for example, the liquid compositions may be cured using UV-radiation and/or heat. Electron beam radiation may also be used. The liquid compositions described above are said to be cured using actinic radiation, i.e., radiation that leads to the production of photochemical activity. For example, actinic radiation may comprise radiation of from about 250 to about 700 nm. Sources of actinic radiation include tungsten halogen lamps, xenon and mercury arc lamps, incandescent lamps, germicidal lamps, fluorescent lamps, lasers and light emitting diodes. UV-radiation can be supplied using a high intensity continuously emitting system such as those available from Fusion UV Systems.

In some embodiments, actinic radiation may be applied to a layer of the liquid composition such that the composition is partially polymerized. The liquid composition may be disposed between the display panel and the substantially transparent substrate and then partially polymerized. The liquid composition may be disposed on the display panel or the substantially transparent substrate and partially polymerized, then the other of the display panel and the substrate may be disposed on the partially polymerized layer.

In some embodiments, actinic radiation may be applied to a layer of the liquid composition such that the composition is completely or nearly completely polymerized. The liquid composition may be disposed between the display panel and the substantially transparent substrate and then completely or nearly completely polymerized. The liquid composition may be disposed on the display panel or the substantially transparent substrate and completely or nearly completely polymerized, then the other of the display panel and the substrate may be disposed on the polymerized layer.

In the assembly process, it is generally desirable to have a layer of the liquid composition that is substantially uniform. The two components are held securely in place. If desired, uniform pressure may be applied across the top of the assembly. If desired, the thickness of the layer may be controlled by a gasket, standoffs, shims, and/or spacers used to hold the components at a fixed distance to each other. Masking may be required to protect components from overflow. Trapped pockets of air may be prevented or eliminated by vacuum or other means. Radiation may then be applied to form the adhesive layer.

The optical assembly may be prepared by creating an air gap or cell between the two components and then disposing the liquid composition into the cell. An example of this method is described in U.S. Pat. No. 6,361,389 B1 (Hogue et. al) and includes adhering together the components at the periphery edges so that a seal along the periphery creates the air gap or cell. Adhering may be carried out using any type of adhesive, e.g., a bond tape such as a double-sided pressure sensitive adhesive tape, a gasket, an RTV seal, etc., as long as the adhesive does not interfere with reworkability as described above. Then, the liquid composition is poured into the cell through an opening at a periphery edge. Alternatively, the liquid composition is injected into the cell maybe using some pressurized injection means such as a syringe. Another opening is required to allow air to escape as the cell is filled. Exhaust means such as vacuum may be used to facilitate the process. Actinic radiation or heat may then be applied as described above to form the adhesive layer.

The optical assembly may be prepared using an assembly fixture such as the one described in U.S. Pat. No. 5,867,241 (Sampica et al.) In this method, a fixture comprising a flat plate with pins pressed into the flat plate is provided. The pins are positioned in a predetermined configuration to produce a pin field which corresponds to the dimensions of the display panel and of the component to be attached to the display panel. The pins are arranged such that when the display panel and the other components are lowered down into the pin field, each of the four corners of the display panel and other components is held in place by the pins. The fixture aids assembly and alignment of the components of an optical assembly with suitable control of alignment tolerances. Additional embodiments of this assembly method are described in Sampica et al. U.S. Pat. No. 6,388,724 B1 (Campbell, et. al) describes how standoffs, shims, and/or spacers may be used to hold components at a fixed distance to each other.

In another embodiment, the thixotropic liquid optically clear adhesive may be applied to one or both of the components to be assembled by means of stencil printing. Stencil printing is a method of transferring a pattern by brushing, spraying, or squeeging the adhesive through the open areas of a stencil cut or fabricated from thin metal, plastic or cardboard. Squeeging is preferred to obtain a smooth and uniformly thick adhesive liquid coating. The stencil preferably has only the outer boundary, or perimeter, defined by the metal, plastic or cardboard, leaving the interior of the stencil completely free of metal, plastic or cardboard. Optionally ribs, or narrow lengths of metal, plastic or cardboard may span the interior of the stencil from one side to the other for reinforcement of the stencil or to prevent sagging of the squeegee in the interior portions of the stencil. The stencil material is preferably metal.

The optical assembly disclosed herein may comprise additional components typically in the form of layers. For example, a heating source comprising a layer of indium tin oxide or another suitable material may be disposed on one of the components. Additional components are described in, for example, US 2008/0007675 A1 (Sanelle et al.).

The display panel may comprise any type of panel such as a liquid crystal display panel. Liquid crystal display panels are well known and typically comprise a liquid crystal material disposed between two substantially transparent substrates such as glass or polymer substrates. As used herein, substantially transparent refers to a substrate that is suitable for optical applications, e.g., has at least 85% transmission over the range of from 460 to 720 nm. Optical substrates may have, per millimeter thickness, a transmission of greater than about 85% at 460 nm, greater than about 90% at 530 nm, and greater than about 90% at 670 nm. On the inner surfaces of the substantially transparent substrates are transparent electrically conductive materials that function as electrodes. In some cases, on the outer surfaces of the substantially transparent substrates are polarizing films that pass essentially only one polarization state of light. When a voltage is applied selectively across the electrodes, the liquid crystal material reorients to modify the polarization state of light, such that an image is created. The liquid crystal display panel may also comprise a liquid crystal material disposed between a thin film transistor array panel having a plurality of thin film transistors arranged in a matrix pattern and a common electrode panel having a common electrode.

The display panel may comprise a plasma display panel. Plasma display panels are well known and typically comprise an inert mixture of noble gases such as neon and xenon disposed in tiny cells located between two glass panels. Control circuitry charges electrodes within the panel which causes the gases to ionize and form a plasma which then excites phosphors to emit light.

The display panel may comprise an organic electroluminescence panel. These panels are essentially a layer of an organic material disposed between two glass panels. The organic material may comprise an organic light emitting diode (OLED) or a polymer light emitting diode (PLED). These panels are well known.

The display panel may comprise an electrophoretic display. Electrophoretic displays are well known and are typically used in display technology referred to as electronic paper or e-paper. Electrophoretic displays comprise a liquid charged material disposed between two transparent electrode panels. Liquid charged material may comprise nanoparticles, dyes and charge agents suspended in a nonpolar hydrocarbon, or microcapsules filled with electrically charged particles suspended in a hydrocarbon material. The microcapsules may also be suspended in a layer of liquid polymer.

The substantially transparent substrate used in the optical assembly may comprise a variety of types and materials. The substantially transparent substrate is suitable for optical applications and typically has at least 85% transmission over the range of from 460 to 720 nm. The substantially transparent substrate may have, per millimeter thickness, a transmission of greater than about 85% at 460 nm, greater than about 90% at 530 nm, and greater than about 90% at 670 nm.

The substantially transparent substrate may comprise glass or polymer. Useful glasses include borosilicate, sodalime, and other glasses suitable for use in display applications as protective covers. One particular glass that may be used comprises EAGLE XG and JADE glass substrates available from Corning Inc. Useful polymers include polyester films such as polyethylene terephalate, polycarbonate films or plates, acrylic films such as polymethylmethacrylate films, and cycloolefin polymer films such as ZEONOX and ZEONOR available from Zeon Chemicals L.P. The substantially transparent substrate preferably has an index of refraction close to that of display panel and/or the adhesive layer; for example, from about 1.4 and about 1.7. The substantially transparent substrate typically has a thickness of from about 0.5 to about 5 mm.

The substantially transparent substrate may comprise a touch screen. Touch screens are well known and generally comprise a transparent conductive layer disposed between two substantially transparent substrates. For example, a touch screen may comprise indium tin oxide disposed between a glass substrate and a polymer substrate.

The optical assembly disclosed herein may be used in a variety of optical devices including, but not limited to, a handheld device such as a phone, a television, a computer monitor, a projector, a sign. The optical device may comprise a backlight.

### EXAMPLES

Materials used in the following examples are described in Table 1.

TABLE 1

| Abbreviation or | |
|---|---|
| Trade Name | Description |
| CN9018 | Urethane diacrylate (Sartomer Co., Exton, PA) |
| CD611 | Alkoxylated tetrahydrofuranyl acrylate (Sartomer Co., Exton, PA) |
| SR506A | Isobornyl acrylate (Sartomer Co., Exton, PA) |
| TPO-L | Ethyl-2,4,6-trimethylbenzoylphenylphosphinate, photoinitiator (BASF Corp., |
| | Florham Park, NJ) |
| BISOMER | Polypropylene glycol monoacrylate (Cognis Ltd., Southampton, UK) |
| PPA6 | |
| Soybean oil | Plasticizer (Sigma-Aldrich Chem. Co., St. Louis, MO) |
| CN307 | Polybutadiene diacrylate (Sartomer Co., Exton, PA) |
| LIR-30 | Liquid isoprene rubber (Kuraray Co., Ltd, Tokyo JP) |
| NORSOCYL | 2-Ethylhexyl acrylate (Arkema Inc., Philadelphia, PA) |
| 2-EHA | |
| 4812/75F | Lauryl acrylate (Cognis Corp. USA, Cincinnati, OH) |
| SR335 | Lauryl acrylate (Sartomer Co.) |
| 4-HBA | 4-Hydroxybutyl acrylate (BASF Corp.) |
| JONCRYL 960 | Acrylic oligomer (BASF Corp.) |
| JONCRYL 963 | Acrylic oligomer (BASF Corp.) |
| KE311 | Rosin ester (Arakawa Chemical Ind., Ltd., Osaka, Japan) |
| SILQUEST A- | Methacryloxypropyltrimethoxy silane (Momentive Performance Materials, |
| 174 | Albany, NY) |
| SILQUEST A- | δ-Glycidoxypropyltrimethoxy Silane (Momentive Performance Materials, |
| 187 | Albany, NY) |
| DAROCUR | 50% DAROCUR 1173 (2-Hydroxy-2-methyl-1-phenyl-propan-1-one); and 50% |
| 4265 | TPO (2,4,6-Trimethylbenzoyl-diphenyl-phosphineoxide) |
| | (BASF Corp.) |
| IRGACURE 184 | 1-Hydroxycyclohexyl phenyl ketone (Ciba Specialty Chemicals Corp., |
| | Tarrytown, NY) |
| TC6-33, Part A | Linear polydimethylsiloxane vinyl copolymer (Siltech Corp., Toronto, Canada) |
| TC6-33, Part B | Linear polydimethylsiloxane vinyl copolymer and hydrogen polysiloxane (Siltech |
| | Corp., Toronto, Canada) |
| TC-7-103 | Linear polydimethylsiloxane vinyl copolymer and hydrogen polysiloxane (Siltech |
| | Corp., Toronto, Canada) |
| Silmer 731 | Linear Polydimethylsiloxane Vinyl Copolymer and Hydrogen |
| | Polysiloxane (Siltech Corp., Toronto, Canada) |
| TMCP | (Trimethyl)methylcyclopentadienylplatinum (IV) (Strem Chemicals, Inc., |
| | Newburyport, MA) |
| U-PICA 8966 | Urethane methacrylate oligomer (Japan U-Pica Corp) |
| U-PICA 8967 | Urethane methacrylate oligomer (Japan U-Pica Corp) |
| U-PICA 8967A | Urethane methacrylate oligomer (Japan U-Pica Corp) |
| U-PICA | Urethane methacrylate oligomer (Japan U-Pica Corp) |
| 8967AX | |
| AEROSIL A200 | Fumed silica (Evonik Industries, Parsippany, NJ) |
| AEROSIL R805 | Fumed silica (Evonik Industries, Parsippany, NJ) |
| AEROSIL | Fumed Silica (Evonik Industries, Parsippany, NJ) |
| R816 | |
| HDK H2ORH | Fumed silica (Wacker Chemie AG) |
| ACEMATT | ACEMATT TS100 silica-based matting agent (Evonik, Parsippany, NJ) |
| TS100 | |
| AEROXIDE | Fumed aluminum oxide (Evonik, Parsippany, NJ) |
| ALU130 | |
| BYK 405 | Rheology additive based on a solution of polyhydroxycarboxylic acid amides |
| | (Byk-Chemie GmbH, Wesel, Germany) |
| BYK 410 | Rheology additive based on a solution of a modified urea (Byk-Chemie GmbH, |
| | Wesel, Germany) |
| BYK R-606 | Rheology additive based on a polyhydroxycarboxylic acid ester (Byk-Chemie |
| | GmbH, Wesel, Germany) |
| DBA1000 | Liquid optically clear adhesive based on acrylate chemistry (DuPont, Wilmington, |
| | DE) |
| DISPARLON | Non-reactive polyamide thixotrope (King Industries, Norwalk, CT) |
| 6100 | |
| DISPARLON | Non-reactive polyamide thixotrope (King Industries, Norwalk, CT) |
| 6200 | |
| DISPARLON | Non-reactive polyamide thixotrope (King Industries, Norwalk, CT) |
| 6500 | |
| GENOMER | Acrylated oligoamine resin (Rahn USA Corp., Aurora, IL) |
| 5275 | |
| K-STAY 740 | Hydrophobically modified urethane thickener with pseudoplastic characteristics |
| | (King Industries, Norwalk, CT) |
| LOCA 2312 | Liquid optically clear adhesive based on acrylate chemistry (3M Company, St |
| | Paul, MN) |
| SVR1300 | Liquid optically clear adhesive based on polyisoprene and methacrylate chemistry |
| | (Sony Chemical, Tokyo, Japan) |

### Preparation of Liquid Optically Clear Adhesives

Compositions for Comparative Examples 1-2 (C1-C2) and Examples 1-9 (Ex1-9) comprising liquid optically clear adhesives (LOCAs) were prepared according to Table 2. For a given composition, the LOCA components were charged to a black mixing container, a Max 200 (about 100 cm³), from FlackTek Inc., Landrum, S.C., and mixed using a Hauschild Speedmixer™ DAC 600 FV, from FlackTek Inc., operating at 2200 rpm for 4 minutes.

TABLE 2

| Component | C1 | C2 | Ex 1 | Ex 2 | Ex 3¹ | Ex 4² | Ex 5 | Ex 6 | Ex 7² | Ex 8³ | Ex 9⁴ |
|---|---|---|---|---|---|---|---|---|---|---|---|
| CN9018 | 35 | 33 | 31 | 39 | 29 | | | | | 40 | 49 |
| CD611 | 24 | 23 | 22 | 25 | 25 | | | | | 21 | 18 |
| SR506A | 40 | 38 | 36 | 20 | 20 | | | | | 17 | 14 |
| TPO-L | 1 | 1 | 1 | 1 | 1 | | 0.8 | 0.8 | | 1 | 1 |
| BISOMER | | | | 15 | 15 | | | | | 13 | 11 |
| PPA6 | | | | | | | | | | | |
| Soybean oil | | 5 | 10 | | 10 | | 16.4 | | | 8.5 | 7 |
| CN307 | | | | | | | 32.7 | 32.7 | | | |
| LIR-30 | | | | | | | 16.4 | 32.7 | | | |
| NORSOCRYL | | | | | | | 32.7 | | | | |
| 2-EHA | | | | | | | | | | | |
| 4812/75F | | | | | | | | 32.7 | | | |
| IRGACURE | | | | | | | 1 | 1 | | | |
| 184 | | | | | | | | | | | |
| TC6-33, | | | | | | 25 | | | | | |
| Part A | | | | | | | | | | | |
| TC6-33, | | | | | | 25 | | | | | |
| Part B | | | | | | | | | | | |
| TC-7-103 | | | | | | | | | 50.0 | | |
| TMCP 3.66% | | | | | | 0.08 | | | 0.08 | | |
| in toluene | | | | | | | | | | | |

¹viscosity of liquid composition = 600 cps
²amount of platinum metal per total composition = 36 ppm
³viscosity of liquid composition = 1300 cps
⁴viscosity of liquid composition = 3000 cps

### Hardness Measurement

Sample pucks were made by filling a four cavity mold with each of the LOCAs described above. The cavity size was 1″ diameter×0.25″ thick cut from an aluminum plate. The mold comprised three components; a glass base, a polyethylene terephalate release liner and the aluminum plate with cavities. The three elements of the mold, glass base, release liner and aluminum cavity were clamped together prior to filling with LOCA. The filled molds were exposed to UV radiation by passing each through a UV light system, a Model F300S equipped with a type H bulb and a model LC-6 conveyor system all from Fusion UV Systems, Inc, Gaithersburg, Md. The molds were run through the system 5 times at as speed of 4″/sec. The molds were then turned over and run an additional 5 times at as speed of 4″/sec through the light system, exposing the partially cured LOCA though the glass plate, to ensure complete cure of the LOCAs. The total UVA energy each side received was about 2,500 mJ/cm², as measured by UV Power Puck II available from EIT, Inc. Sterling, Va.

Hardness was measured with a Shore A Durometer from Rex Gauge Company, Inc. Buffalo Grove, Ill., immediately after the pucks cooled to room temperature for all the examples except for Examples 4 and 7, which were allowed to cure for a minimum of 16 hours at room temperature.

### Viscosity Measurement

Viscosity measurements were made by using an AR2000 Rheometer equipped with a 40 mm, 1° stainless steel cone and plate from TA Instruments, New Castle, Del. Viscosities were measured using a steady state flow procedure with a frequency from 0.01 to 25 sec⁻¹ with a 28 μm gap between cone and plate at 25° C. Viscosities are reported for compositions at 25° C. and shear rate 1 sec⁻¹.

### Cleavage Strength and Total Energy

Cleavage strength measurements were made using a modified ASTM D 1062-02 Cleavage Strength test method. LOCA was placed between standard 1″×3″ microscope slides over an overlapping area of 1 in² and a thickness of 5 mils using 5 mil ceramic spacer beads which were placed on the adhesive before laminating the two glass slides together. Lamination consisted of placing the second slide, by hand, on top of the first slide having the LOCA and beads, and manually applying pressure. The LOCA between the slides was cured for 10 seconds with an Omnicure 2000 high pressure Hg spot cure source (ca. 2500 mJ/cm² UVA energy) from EXFO Photonic Solutions, Inc., Mississauga, Ontario, Canada. The bonded glass slides were then bonded to offset aluminum blocks specified in ASTM D 1062-02, using 3M™ Scotch-Weld™ Epoxy Adhesive DP100 available from the 3M Company, St. Paul, Minn., and allowed to cure overnight before testing. This also allowed the 1-part silicone to cure (Ex4 and 7). Cleavage force was measured using an MTS Insight 30 EL Electromechanical Testing System, Eden Prairie, Minn. The crosshead speed was 2 inches/min at 72° F. Results are reported as maximum tear strength, i.e. cleavage strength, (N/mm) and total energy (kg*mm). Failure mode is reported as either adhesive or cohesive.

### Shrinkage Measurement

Percent volume shrinkage was measured using an Accupyc II 1340 Pycnometer from Micromeritics Instrument Corporation, Norcross, Ga. An uncured LOCA sample of known mass was placed in a silver vial of the pycnometer. The vial was placed in the pycnometer and the volume of the sample was measured and the density of the LOCA was determined based on the volume and mass of the sample. Sample mass was about 3.5 grams. The density of a cured LOCA sample was measured following the same procedure as that of the uncured. Cured LOCA samples were prepared by following a similar procedure as described for the measurement of hardness, except the mold was made from teflon plate and the cavity size was 3.27 mm thickness and 13.07 mm in diameter. Volume shrinkage was then calculated from the following equation:

{[(1/Avg Liquid Density)−(1/Avg Cured Density)]/(1/Avg Liquid Density)}×100%

### Reworkability Measurement

A qualitative determination of the ability to debond the LOCA, i.e. reworkability, from a glass slide was made by the following procedure. LOCA was placed on a 2″ by 3″ glass slide with 1 mm thickness. The LOCA thickness was maintained at 5 mils by using 5 mil ceramic spacer beads which were placed on the adhesive before laminating the two glass slides together. Lamination consisted of placing the second slide, by hand, on top of the first slide having LOCA and beads, and manually applying pressure. Curing of the LOCA followed the procedure described above for the hardness measurement. After curing, the samples were left over night at ambient conditions. Reworkability was determined by taking a razor blade edge, about 1.5″ in length and sliding it between the two glass slides, on the 2″ side of the glass slide, to initiate a cleavage of the cured LOCA. A manual force was applied to the razor blade to pry open the glass slides. The time to completely separate the two glass slides while applying the force was recorded. Additionally, whether or not the glass slide broke under the applied force was also recorded. The lower the time to debond the two glass plates is generally thought to correlate to improved reworkability. If the glass slide broke during the process, the remaining glass attached to the other slide was removed by a similar procedure. The total time to separate all the glass was reported. The lower the time to completely debond the two glass plates was generally thought to correlate to improved reworkability. Additionally, the debonding mode, whether or not the glass broke and to what extend, was also monitored and reported.

TABLE 3

| | | | Cleavage | Total | | |
|---|---|---|---|---|---|---|
| | Shore A | Visc. | Strength | energy | Failure | Shrinkage |
| Ex. | Hardness | (cps) | (N/mm) | (kg * mm) | mode | (% Vol) |
| C1 | 8 | 638 | 49.9 | 103.9 | adhesive | 9.1 |
| C2 | <2¹ | 613 | 17.8 | 40.8 | adhesive | 5.4 |
| Ex 1 | 8 | 1250 | 10.1 | 10.2 | adhesive | 4.6 |
| Ex 2 | <2¹ | 543 | 9.9 | 25.6 | adhesive | 4.4 |
| Ex 3 | <2¹ | 570 | 6.9 | 18.7 | adhesive | 4.0 |
| Ex 4 | 8-10 | 3500 | 5.3 | 23.1 | cohesive | 2.6 |
| Ex 5 | 3-4 | 270 | 2.0 | 1.6 | adhesive | 2.92 |
| Ex 6 | 9 | 1460 | 5.6 | 3.4 | adhesive | 2.65 |
| Ex 7 | <2¹ | 340 | 3.89 | 7.6 | cohesive | 1.34 |

¹<2 indicates the sample hardness was not measurable on the shore A hardness scale. This value is an estimate.

TABLE 4

| Ex. | Time to Debond | Debonding Mode |
|---|---|---|
| C1 | >10 min | Both glass slides severely broken |
| C2 | >10 min | Both glass slides severely broken |
| Ex 1 | 2 min, 10 sec | Removed without breakage |
| Ex 2 | 1 min, 50 sec | Removed without breakage |
| Ex 3 | 3 min, 10 sec | Top glass slide broken into several pieces |
| Ex 4 | 7 min, 20 sec | Top glass slide broken into several pieces |
| Ex 5 | 20 sec | Removed without breakage |
| Ex 6 | 20 sec | Top glass broke once |
| Ex 7 | 20 sec | Removed without breakage |

### Rework of Assemblies

To facilitate cleaning of partially cured and uncured LOCAs remaining on the surface of a cover sheet and/or LCD panel, the separated components were fully cured using appropriate curing conditions. Cured LOCA can be removed by stretch release due to its elastic property. Residual cured LOCA can be removed by applying pressure sensitive adhesive tape over the cover sheet and LCD panel. Residual cured LOCA can also be removed by placing a cylindrical rod over the residual cured LOCA on the cover sheet and LCD panel.

Fully cured assemblies of a cover sheet and LCD panel can be separated by inserting a taut wire of e.g., stainless steel, glass fibre or nylon, with diameter slightly less than the gap size between the two components. The taut wire can then be passed through the two components by pulling the wire tightly up against and side of one of the components. This forces the wire to conform and exert a pressure on the surface of the cover sheet, thus facilitating debonding of the two components. After the wired is pulled through, the two components can be separated by manual twisting.

### Thixotropic LOCAs

### Viscosity Measurement of Thixotropic Liquid Optically Clear Adhesive Compositions.

Viscosity measurements were made by using an AR2000 Rheometer equipped with a 40 mm, 1° stainless steel cone and plate from TA Instruments, New Castle, Del. Viscosities were measured using a steady state flow procedure with a frequency from 0.001 to 100 sec⁻¹ with a 28 μm gap between cone and plate at 25° C.

### Rotational Creep Measurement of Thixotropic Liquid Optically Clear Adhesive Compositions.

Rotational creep measurements were made using an AR2000 Rheometer equipped with a 40 mm diameter, 1° cone at 25° C., and recorded as the rotational angle of the cone in radians when a stress of 10 Pa is applied to the adhesive composition for 2 minutes.

### Delta Measurement of Thixotropic Liquid Optically Clear Adhesive Compositions.

Delta measurements were made using an AR2000 Rheometer equipped with a 40 mm diameter, 1° cone at 25° C., and recorded as degrees when a torque of 80 microN·m is applied at a frequency of 1 Hz for 60 seconds.

### Recovery Time Measurement of Thixotropic Liquid Optically Clear Adhesive Compositions.

Recovery time measurements were made using an oscillatory procedure on an AR2000 Rheometer equipped with a 40 mm diameter, 1° cone at 25° C., and recorded as time in seconds for delta to decrease from its maximum to 35 degrees after a torque of 1000 microN·m is applied to the liquid optically clear adhesive at a frequency of 1 Hz for 60 seconds followed by a torque of 80 microN·m.

Compositions for Comparative Example 3 (C3) and Example 10 were prepared according to Table 5. Components were added to a white mixing container, a Max 300 (about 500 cm³), from FlackTek Inc., Landrum, S.C.), and mixed using a Hauschild Speedmixer™ DAC 600 FV, from FlackTek Inc., operating at 2200 rpm for 4 minutes. In the case of Example 10, the sides of the container were scraped down to make sure all the fumed silica was incorporated, then the container was mixed for an additional 4 minutes.

TABLE 5

| | C3 | | Ex 10 | |
|---|---|---|---|---|
| Component | % Loading | Mass (g) | % Loading | Mass (g) |
| U-Pica 8967 | 68.4 | 69.8 | 50.0 | 150.00 |
| CD611 | | | 14.0 | 41.88 |
| KE311 | 7.1 | 7.2 | | |
| SR506A | 11.6 | 11.8 | 11.2 | 33.50 |
| Bisomer PPA6 | | | 8.4 | 25.13 |
| Soybean oil | | | 8.4 | 25.50 |
| 4-HBA | 9.8 | 10 | | |
| SILQUEST A-174 | 0.2 | 0.2 | | |
| Lucirin TPO-L | 2.9 | 3.00 | 1.0 | 3.00 |
| HDK H2ORH | | | 7 | 21.00 |

The mixture for Example 10 was sandwiched between 2″×3″ microscope slides at a thickness of about 200 microns. % T and haze were measured using a HazeGard Plus (BYK-Gardner USA, Columbia, Md.). The fresh coating had 92.9% T (uncorrected for glass) and a haze of 1.49%. After 72 hours at 60° C./85% RH, the coating had 93.0% T (uncorrected for glass) and a haze of 0.91%.

The viscosities for Comparative Example 3 and Example 10 were measured on an AR2000 Rheometer (TA Instruments, New Castle, Del.), equipped with a 40 mm, 1° stainless steel cone and plate from TA Instruments, New Castle, Del. at 25° C. The shear rate was increased from 0.001 sec⁻¹ to 100 sec⁻¹. Viscosities at various shear rates are shown in Table 6. When a bead of Example 10 was deposited on a glass slide from a syringe/needle assembly, it showed no perceivable sag (non-sag) to the naked eye after 1 minute. Example 10 meets the criteria specified herein for viscosity of 18,000 cps to 140,000 cps at a shear rate of 1 sec⁻¹ and a viscosity of 700,000 cps to 4,200,000 cps at 0.01 sec⁻¹. However a bead of C3 had significant sag to the naked eye after 1 minute despite a viscosity of 19,000 cps at 1 sec⁻¹. C3 meets the criterion herein for a viscosity of 18,000 cps to 140,000 cps at a shear rate of 1 sec⁻¹. However C3 has a viscosity of only 20,400 cps at a shear rate of 0.01 sec⁻¹ and misses the criterion specified herein for a viscosity of 700,000 cps to 4,200,000 cps at 0.01 sec⁻¹.

TABLE 6

| | C3 | Ex 10 |
|---|---|---|
| Shear rate | Viscosity | Viscosity |
| (sec⁻¹) | (cps) | (cps) |
| 0.01 | 20,400 | 4,159,000 |
| 0.1 | 19,000 | 870,600 |
| 1 | 19,000 | 132,800 |
| 10 | 19,100 | 30,000 |

The displacement creep values for Comparative Example 3 and Example 10 were measured using an AR2000 Rheometer and a 40 mm diameter, 1° cone at 25° C., and is defined as the rotational angle of the cone when a stress of 10 Pa is applied to the adhesive for two minutes. Example 10 has a displacement creep of 0.021 radians after two minutes and meets the criterion specified herein of <0.1 radians. However C3 fails this criterion with a displacement creep of 1.08 radians after two minutes.

Thixotropic liquid optically clear adhesives were prepared by adding the components in Table 7 to white mixing containers, a Max 300 (about 500 cm³), from FlackTek Inc., Landrum, S.C., and mixed using a Hauschild Speedmixer™ DAC 600 FV, from FlackTek Inc., operating at 2200 rpm. After mixing for 4 minutes, the sides of the containers were scraped down to make sure all the fumed silica was incorporated, then the containers were mixed for an additional 4 minutes.

TABLE 7

| | C4 | Ex 11 | Ex 12 |
|---|---|---|---|
| Component | % Loading | % Loading | % Loading |
| U-Pica 8967A | 11.2 | 34.2 | 15.8 |
| U-Pica 8966A | 7.6 | | 12.1 |
| Joncryl 960 | | | 26.2 |
| Joncryl 963 | 20 | | |
| KE311 | 26.9 | 11.4 | 18.9 |
| CD611 | | 12.3 | |
| SR335 | 11.0 | | |
| SR506A | 16.4 | 17.1 | 18.9 |
| Bisomer PPA6 | | 9.5 | |
| Soybean oil | | 9.5 | |
| A187 | | | 0.2 |
| A174 | 0.2 | | |
| TPO-L | | 1 | |
| Darocur 4265 | 2 | | 2 |
| Aerosil A200 | 4.8 | 5 | |
| Aerosil R805 | | | 5.9 |

The viscosities of Comparative Example 4 and Examples 11 and 12 were measured as described above for Comparative Example 3 and Example 10; results are shown in Table 8. The thixotropy was considered good if it had a viscosity of 18 Pa·s to 140 Pa·s at a shear rate of 1 sec⁻¹ and a viscosity of 700 Pa·s to 4200 Pa·s. at 0.01 sec⁻¹.

Comparative Example 4 and Examples 11 and 12 were each sandwiched between 2″×3″ microscope slides at a thickness of about 200 microns and cured using a 300 W/inch Fusion H bulb and a UVA energy of 3000 mJ/cm² as measured by a UV Power Puck (EIT, Inc., Sterling, Va.). Haze was measured using a HazeGard Plus (BYK-Gardner USA, Columbia, Md.). The values for haze are reported in Table 8. The cured adhesive was considered good if the haze was <1%.

Weight loss was measured by placing approximately 15 g of the thixotrope in a container, a Max 300 (about 500 cm³), from FlackTek Inc., Landrum, S.C., and subjecting the container with the thixotrope to a vacuum of 2000 Pa for 2 minutes at 25° C. The weight of the thixotrope before and after the vacuum treatment was used to calculate % weight loss, which is reported in Table 8. Example 11 with a weight loss of 0.033% gave no bubbling during vacuum lamination at a pressure of 2000 Pa whereas C4 with a weight loss of 0.177% gave considerable bubbling during vacuum lamination at a pressure of 2000 Pa.

TABLE 8

| | C4 | Ex 11 | Ex 12 |
|---|---|---|---|
| Viscosity (cps) | 4,182,000 | 1,480,000 | 974,000 |
| Shear rate 0.01 sec⁻¹ | | | |
| Viscosity (cps) | 686,000 | 613,000 | 185,000 |
| Shear rate 0.1 sec⁻¹ | | | |
| Viscosity (cps) | 123,000 | 91,000 | 55,600 |
| Shear rate 1 sec⁻¹ | | | |
| Thixotropy result | good | good | good |
| Haze | 5% | 0.4% | 0.7% |
| Haze result | poor | good | good |
| Weight Loss | 0.117% | 0.033% | |
| Bubbling during | yes | no | |
| vacuum lamination? | | | |

Compositions for thixotropic LOCAs were prepared according to Table 9. Unless noted otherwise below, components were added to a white mixing container, (a Max 100 cup, from FlackTek Inc., Landrum, S.C.) and mixed using a Hauschild Speedmixer™ DAC 600 FV, from FlackTek Inc., operating at 2200 rpm for 4 minutes.

For comparative examples C6 through C13, the BYK additive was added to the LOCA in a white mixing container (a Max 100 cup, from FlackTek Inc., Landrum, S.C.), and mixed using a Hauschild Speedmixer™ DAC 600 FV, from FlackTek Inc., operating at 2200 rpm for 4 minutes. The A200 was added to the contents of the mixing cup, and then mixed using a Hauschild Speedmixer™ DAC 600 FV, from FlackTek Inc., operating at 2200 rpm for 4 minutes.

For comparative Examples C19 through C21, the mixed contents were heated to 100° C. for 30 minutes to incorporate the thixotropic additive. After heating, the mixed contents were cooled to room temperature and then mixed using a Hauschild Speedmixer™ DAC 600 FV, from FlackTek Inc., operating at 2200 rpm for 4 minutes.

Comparative Example C30 is LOCA 2312 unmodified.

TABLE 9

| | | Desired Weight | Amount Added per 20 |
|---|---|---|---|
| Example | Thixotrope | Percent | grams of LOCA 2312 |
| 13 | HDK H20 RH | 5 | 1.05 |
| 14 | A200 | 5 | 1.05 |
| C5 | BYK 410 | 2 | 0.41 |
| C6 | BYK 405 | 0.4 | 0.83 |
| | A200 | 2 | 0.41 |
| C7 | BYK 405 | 0.9 | 0.18 |
| | A200 | 3 | 0.62 |
| C8 | BYK 405 | 1.2 | 0.24 |
| | A200 | 4 | 0.83 |
| C9 | BYK 405 | 1.5 | 0.30 |
| | A200 | 5 | 1.05 |
| C10 | BYK R-606 | 0.1 | 0.03 |
| | A200 | 2 | 0.41 |
| C11 | BYK R-606 | 0.45 | 0.09 |
| | A200 | 3 | 0.62 |
| C12 | BYK R-606 | 0.6 | 0.12 |
| | A200 | 4 | 0.83 |
| C13 | BYK R-606 | 0.75 | 0.15 |
| | A200 | 5 | 1.05 |
| C14 | Acematt TS100 | 5 | 1.05 |
| C15 | Aerosil R805 | 4 | 0.83 |
| C16 | Aeroxide Alu130 | 5 | 1.05 |
| C17 | HDK H20 RH | 2.5 | 0.51 |
| C18 | K-Stay 740 | 0.5 | 0.10 |
| C19 | Disparlon 6100 | 1.5 | 0.30 |
| C20 | Disparlon 6200 | 1.5 | 0.30 |
| C21 | Disparlon 6500 | 1 | 0.20 |
| C30 | None | 0 | 0 |

For Example 15, 0.26 grams of A100 were added to 5 grams of DBA1000 in a white mixing container (a Max 60 cup, from FlackTek Inc., Landrum, S.C.) and mixed using a Hauschild Speedmixer™ DAC 600 FV, from FlackTek Inc., operating at 2200 rpm for 4 minutes. Comparative Example C30 is DBA1000 unmodified.

Compositions for comparative examples of thixotropic LOCAs based on SVR1300 were prepared according to Table 10. Unless noted otherwise below, components were added to a white mixing container, (a Max 100 cup, from FlackTek Inc., Landrum, S.C.) and mixed using a Hauschild Speedmixer™ DAC 600 FV, from FlackTek Inc., operating at 2200 rpm for 4 minutes. Comparative Example C32 is SVR1300 unmodified.

TABLE 10

| | | Desired Weight | Amount Added per 5 |
|---|---|---|---|
| Example | Thixotrope | Percent | grams of SVR1300 |
| C22 | HDK H20 RH | 1.5 | 0.08 |
| C23 | A200 | 5 | 0.26 |
| C24 | R805 | 5 | 0.26 |
| C25 | R816 | 5 | 0.26 |
| C26 | BYK410 | 3 | 0.16 |
| | A200 | 5 | 0.26 |
| C27 | BYK410 | 2 | 0.10 |
| | A200 | 4 | 0.21 |
| C28 | BYK 405 | 3 | 0.16 |
| | A200 | 4 | 0.21 |
| C29 | GENOMER 5275 | 3 | 0.16 |
| | A200 | 4 | 0.21 |

### Rheology Measurements

Viscosities, displacement creep and delta measurement values can be found in Table 11.

TABLE 11

| | | | | | | Creep | |
|---|---|---|---|---|---|---|---|
| | | Viscosity (cP) at Shear Rate (sec⁻¹) | | | | Resistance | Delta |
| Ex. | Thixotrope | 0.01 | 0.1 | 1 | 10 | (rad) | (degrees) |
| 13 | HDK H20 RH | 8,355,000 | 473,500 | 53,200 | 9,800 | 0.0282 | 25.1700 |
| 14 | A200 | 1,061,000 | 384,800 | 62,700 | 13,900 | 0.0004 | 10.2100 |
| 15 | DBA1000/A100 | 982,600 | 266,600 | 43,350 | 10,780 | 0.0101 | 40.1300 |
| C5 | BYK 410 | 389,400 | 116,700 | 31,900 | 5,900 | 0.1051 | 45 |
| C6 | BYK 405 | 220,100 | 90,200 | 15,500 | 4,100 | 0.0406 | 30.35 |
| | A200 | | | | | | |
| C7 | BYK 405 | 424,300 | 238,800 | 45,600 | 8,900 | 0.0015 | 9.689 |
| | A200 | | | | | | |
| C8 | BYK 405 | 1,037,000 | 237,500 | 36,800 | 7,000 | 0.0645 | 38.41 |
| | A200 | | | | | | |
| C9 | BYK 405 | 7,222,000 | 761,400 | 164,600 | 19,300 | 0.0001 | 7 |
| | A200 | | | | | | |
| C10 | BYK R-606 | 544,200 | 142,500 | 23,800 | 5,400 | 0.1102 | 42 |
| | A200 | | | | | | |
| C11 | BYK R-606 | 2,292,000 | 396,200 | 67,100 | 30,800 | 0.0014 | 19 |
| | A200 | | | | | | |
| C12 | BYK R-606 | 7,919,000 | 1,247,000 | 135,200 | 17,900 | 0.0002 | 7 |
| | A200 | | | | | | |
| C13 | BYK R-606 | 10,920,000 | 1,283,000 | 260,200 | 31,800 | 0.0001 | 4 |
| | A200 | | | | | | |
| C14 | Acematt TS100 | 60,100 | 41,300 | 12,800 | 5,400 | 1.9800 | 85 |
| C15 | Aerosil R805 | 64,500 | 29,700 | 9,500 | 4,100 | 2.3400 | 81 |
| C16 | Aeroxide Alu130 | 762,500 | 186,900 | 20,500 | 5,300 | 1.4700 | 64.9500 |
| C17 | HDK H20 RH | 67,700 | 27,500 | 7,400 | 3,300 | 3.5749 | 70.2100 |
| C18 | K-Stay 740 | 1,900 | 1,600 | 1,500 | 1,500 | 12.9844 | 89.9200 |
| C19 | Disparlon 6100 | 115,300 | 60,600 | 14,500 | 4,500 | 0.0708 | 28.2800 |
| C20 | Disparlon 6200 | 20,300 | 12,900 | 5,800 | 2,800 | 0.1037 | 35.8600 |
| C21 | Disparlon 6500 | 142,500 | 46,300 | 11,900 | 3,811 | 4.0900 | 75.1200 |
| C22 | SVR1300/HDK H20 RH | 2,663,000 | 455,100 | 85,410 | 30,790 | 0.0868 | 35.3700 |
| C23 | SVR1300/A200 | 12,910 | 10,500 | 10,400 | 10,100 | | |
| C24 | SVR1300/R805 | 408,000 | 350,400 | 24,900 | 11,500 | 0.0004 | 18.9800 |
| C25 | SVR1300/R816 | 528,100 | 63,720 | 12,060 | 9,500 | 2.2000 | 84.9700 |
| C26 | SVR1300/A200(5%)/BYK410(3%) | 10,150,000 | 1,033,000 | 118,200 | 22,000 | 0.0002 | 14.4100 |
| C27 | SVR1300/A200(4%)/BYK410(2%) | 1,104,000 | 624,200 | 78,000 | 16,700 | 0.0223 | 31.8200 |
| C28 | SVR1300/A200(4%)/BYK410(3%) | 4,612,000 | 521,200 | 73,500 | 17,100 | 0.0042 | 44.4100 |
| C29 | SVR1300/A200(4%)/GENOMER | 21,300 | 18,600 | 18,100 | 14,100 | 1.2196 | 87.3300 |
| | 5275(3%) | | | | | | |
| C30 | LOCA 2312 | 1,340 | 1,360 | 1,340 | 1,350 | | |
| C31 | DBA1000 | | 1,210 | 1,340 | 1,360 | | |
| C32 | SVR1300 | 2,520 | 4,390 | 4,350 | 4,320 | | |

### Optical Properties of Thixotropic LOCAs

Transmission, % T, and haze were measured using a HazeGard Plus (BYK-Gardner USA, Columbia, Md.). Results are compiled in Table 12, with a minimum of three measurements for each property.

TABLE 12

| | | Optical Properties | |
|---|---|---|---|
| Example | Thixotrope | Transmission | Haze |
| 13 | HDK H20 RH | 91.7 | 1.97 |
| 14 | A200 | 92.2 | 1.99 |
| 15 | DBA1000/A100 | 92.1 | 1.99 |
| C5 | BYK 410 | 90.0 | 28.40 |
| C6 | BYK 405 | 92.0 | 3.89 |
| | A200 | | |
| C7 | BYK 405 | 91.7 | 3.18 |
| | A200 | | |
| C8 | BYK 405 | 92.2 | 2.57 |
| | A200 | | |
| C9 | BYK 405 | 92.2 | 2.04 |
| | A200 | | |
| C10 | BYK R-606 | 91.8 | 2.88 |
| | A200 | | |
| C11 | BYK R-606 | 92.1 | 2.41 |
| | A200 | | |
| C12 | BYK R-606 | 91.7 | 4.07 |
| | A200 | | |
| C13 | BYK R-606 | 92.0 | 2.59 |
| | A200 | | |
| C14 | Acematt TS100 | 92.2 | 1.32 |
| C15 | Aerosil R805 | 92.2 | 1.11 |
| C16 | Aeroxide Alu130 | 85.8 | 54.30 |
| C17 | HDK H20 RH | 91.6 | 2.83 |
| C18 | K-Stay 740 | 92.1 | 2.39 |
| C19 | Disparlon 6100 | 90.9 | 21.80 |
| C20 | Disparlon 6200 | 90.1 | 46.80 |
| C21 | Disparlon 6500 | 90.5 | 31.10 |
| C22 | SVR1300/HDK H20 RH | 90.1 | 7.60 |
| C23 | SVR1300/A200 | 91.4 | 1.79 |
| C24 | SVR1300/R805 | 90.5 | 6.91 |
| C25 | SVR1300/R816 | 91.5 | 1.99 |
| C26 | SVR1300/A200(5%)/BYK410(3%) | 91.4 | 4.99 |
| C27 | SVR1300/A200(4%)/BYK410(2%) | 91.4 | 4.99 |
| C28 | SVR1300/A200(4%)/BYK410(3%) | 91.7 | 4.37 |
| C29 | SVR1300/A200(4%)/GENOMER | 90.4 | 9.93 |
| | 5275(3%) | | |
| C30 | EAS1616 | 92.3 | 0.86 |

Stock solution 1 (SS1) was prepared by mixing 85.45 parts U-Pica 8967A, 30.86 parts CD611, 42.73 parts SR506A, 28.48 parts KE311, 213.74 parts Bisomer PPA6, 23.74 parts soybean oil and 2.50 parts TPO-L where parts are parts by weight.

Stock solution 2 (SS2) was prepared by mixing 93.2 parts CN9018, 80.4 parts CD611, 64.3 parts SRS506A, 48.2 parts Bisomer PPA6, 32.2 parts soybean oil and 3.22 parts TPO-L.

Stock solution 3 (SS3) was prepared by mixing 185.3 parts U-Pica 8967A, 73.4 parts U-Pica 8967AX, 40.6 parts CD611, 56.2 parts SR506A, 67.8 parts KE311, 31.2 parts Bisomer PPA6, 38 parts soybean oil, and 7.5 parts TPO-L.

The following comparative examples and examples were prepared according to Table 13.

TABLE 13

| | C31 | C32 | C33 | C34 | E16 | E17 | C35 | E18 | C36 | C37 |
|---|---|---|---|---|---|---|---|---|---|---|
| SS1 | 40 | 39.6 | 39.2 | 38.8 | 38.4 | 38 | | | | |
| SS2 | | | | | | | 40 | 38 | | |
| SS3 | | | | | | | | | 40 | 38 |
| A200 | 0 | 0.4 | 0.8 | 1.2 | 1.6 | 2 | 0 | 2 | 0 | 2 |
| Wt % | 0% | 1% | 2% | 3% | 4% | 5% | 0% | 5% | 0% | 5% |
| A200 | | | | | | | | | | |

The viscosities, delta, rotational creep, and haze of C31-C37 and E16-E18 are shown in Table 14.

TABLE 14

| | Viscosity | Viscosity | Viscosity | Viscosity | Viscosity | | Creep | |
|---|---|---|---|---|---|---|---|---|
| | 0.01/sec | 0.1/sec | 1/sec | 10/sec | 100/sec | delta | displacement | |
| | Pa · s | Pa · s | Pa · s | Pa · s | Pa · s | (degrees) | (radians) | Haze |
| C31 | 2.2 | 2.214 | 2.176 | 2.175 | 2.182 | 89.9 | 9.46 | <2 |
| C32 | 9.246 | 9.238 | 4.597 | 3.105 | 2.708 | 84.4 | 5.58 | <2 |
| C33 | 177 | 38.7 | 10.39 | 4.731 | 3.463 | 58.4 | 1.88 | <2 |
| C34 | 661 | 114 | 22.4 | 7.54 | 4.534 | 29.1 | 0.0723 | <2 |
| E16 | 978 | 269 | 44.2 | 11.9 | 5.957 | 25 | 0.0201 | <2 |
| E17 | 1567 | 583 | 86.8 | 19.5 | 8.128 | 22.1 | 0.0054 | <2 |
| C35 | 0.594 | 0.594 | 0.594 | 0.59 | 0.594 | 89.93 | 35.2 | <2 |
| E18 | 830 | 253 | 69.5 | 12.7 | 3.68 | 13.7 | 0.0021 | <2 |
| C36 | 14.6 | 14.6 | 14.5 | 14.5 | 14.7 | 89.79 | 1.438 | <2 |
| C37 | 2560 | 482 | 104 | 43.7 | 31.2 | 17.8 | 0.00016 | <2 |

The recovery times for delta to decrease to 35 degrees from delta maximum are listed in Table 15.

TABLE 15

| | C31 | C32 | C33 | C34 | E16 | E17 | C35 | E18 | C36 | C37 |
|---|---|---|---|---|---|---|---|---|---|---|
| Recovery time (sec) | nd | nd | > delta | > delta | 44.6 | <9 | nd | <10 | nd | <10 |
| to reach delta = 35° | | | 80° | 45° | | | | | | |
| | | | for 600 sec | for 600 sec | | | | | | |
| Minimum delta | nd | nd | 56.3 | 28.5 | 22.4 | 19.6 | nd | 14.3 | nd | 24.5 |
| (degrees) | | | | | | | | | | |
| Maximum delta | nd | nd | 88.8 | 86.4 | 81.1 | 54.8 | nd | 73.5 | nd | 44.1 |
| (degrees) | | | | | | | | | | |

Comparative Examples C38 and C39 were prepared according to Table 16.

TABLE 16

| | | | Amount Added per |
|---|---|---|---|
| | | | 24.25 grams of Silmer 731 |
| | | Desired Weight | containing 21.5 ppm Pt |
| Example | Thixotrope | Percent | as TMCP |
| C38 | Aerosil R816 | 3 | 0.75 |
| C39 | None | 0 | 0 |

The viscosities for Comparative Examples C38 and C39 were measured on an AR2000 Rheometer (TA Instruments, New Castle, Del.), equipped with a 40 mm, 1° stainless steel cone and plate from TA Instruments, New Castle, Del. at 25° C. The shear rate was increased from 0.001 sec⁻¹ to 100 sec⁻¹. Viscosities at various shear rates are shown in Table 17.

TABLE 17

| | | Viscosity (Pa · s) at | | | |
|---|---|---|---|---|---|
| | | Shear Rate (sec⁻¹) | | | |
| Example | Thixotrope | 0.01 | 0.1 | 1 | 10 |
| C38 | Aerosil R816 | 9,132 | 557 | 52 | 8.96 |
| C39 | none | 1.630 | 1.610 | 1.580 | 1.580 |

A 150 micron thick coating of Example 19 was prepared between 1 mm thick microscope glass slides and exposed to 3000 mJ/cm² UVA energy as measured with an EIT Power Puck II radiometer. Haze and % T, measured with a Byk Gardner HazeGard Plus, were 91.6% and 3.1%, respectively.

A number of embodiments of the invention have been described. It is understood that various modifications may be made without departing from the spirit and scope of the invention. Accordingly, other embodiments are within the scope of the following claims.

1. An optical assembly comprising:
a display panel;
a substantially transparent substrate adhered to the display panel by an adhesive layer disposed between the display panel and the substantially transparent substrate, the adhesive layer comprising:
the reaction product of
a multifunctional (meth)acrylate oligomer, and
a reactive diluent comprising a monofunctional (meth)acrylate monomer having a viscosity of from about 4 to about 20 cps at 25° C.; and
a plasticizer comprising an oil.

2. (canceled)

3. The optical assembly of claim 1,
the multifunctional (meth)acrylate oligomer comprising a multifunctional urethane(meth)acrylate oligomer, and
the monofunctional (meth)acrylate monomer comprising alkoxylated tetrahydrofurfuryl acrylate and isobornyl(meth)acrylate and having a viscosity of from about 4 to about 20 cps at 25° C.

4-8. (canceled)

9. An optical assembly comprising:
a display panel;
a substantially transparent substrate adhered to the display panel by an adhesive layer disposed between the display panel and the substantially transparent substrate, the adhesive layer comprising:
the reaction product of
a multifunctional (meth)acrylate oligomer, and
a reactive diluent comprising a monofunctional (meth)acrylate monomer having a viscosity of from about 4 to about 20 cps at 25° C., and a monofunctional (meth)acrylate monomer having alkylene oxide functionality.

10. (canceled)

11. The optical assembly of claim 9,
the multifunctional (meth)acrylate oligomer comprising a multifunctional urethane(meth)acrylate oligomer,
the monofunctional (meth)acrylate monomer having a viscosity of from about 4 to about 20 cps at 25° C. comprising an alkoxylated tetrahydrofurfuryl(meth)acrylate and isobornyl(meth)acrylate, and
the monofunctional (meth)acrylate monomer having alkylene oxide functionality having from 1 to 10 alkylene oxide units.

12-14. (canceled)

15. An optical assembly comprising:
a display panel;
a substantially transparent substrate adhered to the display panel by an adhesive layer disposed between the display panel and the substantially transparent substrate, the adhesive layer comprising:
the reaction product of
a multifunctional rubber-based (meth)acrylate oligomer, and
a monofunctional (meth)acrylate monomer having a pendant alkyl group of from 4 to 20 carbon atoms; and
a liquid rubber.

16-20. (canceled)

21. The optical assembly of claim 15, the adhesive layer further comprising an oil.

22. (canceled)

23. The optical assembly of claim 1, the adhesive layer being substantially free of tackifier.

24. The optical assembly of claim 1, the adhesive layer further comprising silica.

25. The optical assembly of claim 1,
the adhesive layer having a cleavage strength between glass substrates of about 15 N/mm or less, and
the optical assembly having an area of from about 15 cm² to about 5 m².

26-29. (canceled)

30. An optical assembly comprising:
a display panel;
a substantially transparent substrate; and
a liquid composition disposed between the display panel and the substantially transparent substrate, the liquid composition having a viscosity of from about 100 to about 140,000 cps at 25° C. and 1 sec⁻¹, the liquid composition comprising:
a multifunctional (meth)acrylate oligomer,
a monofunctional (meth)acrylate monomer having a viscosity of from about 4 to about 20 cps at 25° C., and
a plasticizer.

31. The optical assembly of claim 30 wherein the viscosity of the liquid composition is from about 100 to 10,000 cps at 25° C. and 1 sec⁻¹.

32-38. (canceled)

39. An optical assembly comprising:
a display panel;
a substantially transparent substrate; and
a liquid composition disposed between the display panel and the substantially transparent substrate, the liquid composition having a viscosity of from about 100 to about 140,000 cps at 25° C. and 1 sec⁻¹, the liquid composition comprising:
a multifunctional (meth)acrylate oligomer,
a monofunctional (meth)acrylate monomer having a viscosity of from about 4 to about 20 cps at 25° C., and
a monofunctional (meth)acrylate monomer having alkylene oxide functionality.

40. The optical assembly of claim 39 wherein the viscosity of the liquid composition is from about 100 to 10,000 cps at 25° C. and 1 sec⁻¹.

41-68. (canceled)

69. An optically clear adhesive layer comprising:
a liquid optically clear adhesive having a viscosity of less than about 20 Pa·s at a shear rate of 1 sec⁻¹; and
a thixotrope selected from the group consisting of: fumed silica, fumed aluminum oxide, polyhydroxycarboxylic acid amides, polyhydroxycarboxylic acid esters, modified ureas, metal sulfonates, acrylated oligoamines, polyacrylic acids, and modified urethanes;
wherein the optically clear adhesive layer has a haze of about 2% or less;
wherein the optically clear adhesive layer has a viscosity of between about 2 and about 30 Pa·s at a shear rate of 10 sec⁻¹ and a viscosity of between about 700 and about 10,000 Pa·s at a shear rate of 0.01 sec⁻¹;
wherein the optically clear adhesive layer has displacement creep of about 0.2 radians or less when a stress of 10 Pa is applied for about 2 minutes; and
wherein the optically clear adhesive layer has a recovery time of about 60 seconds or less to reach a delta of 35 degrees after a torque of about 1000 microN·m is applied for about 60 seconds at a frequency of 1 Hz and immediately followed by a torque of 80 microN·m at a frequency of 1 Hz.

70-77. (canceled)

78. The optical assembly of claim 9, the adhesive layer being substantially free of tackifier.

79. The optical assembly of claim 9, the adhesive layer further comprising silica.

80. The optical assembly of claim 9,
the adhesive layer having a cleavage strength between glass substrates of about 15 N/mm or less, and
the optical assembly having an area of from about 15 cm² to about 5 m².

81. The optical assembly of claim 15, the adhesive layer being substantially free of tackifier.

82. The optical assembly of claim 15, the adhesive layer further comprising silica.

83. The optical assembly of claim 15,
the adhesive layer having a cleavage strength between glass substrates of about 15 N/mm or less, and
the optical assembly having an area of from about 15 cm² to about 5 m².
